(19) United States
(12) Patent Application Publication
(10) Pub. No.: US 2026/0349659 A1
(43) Pub. Date: Nov. 5, 2026

(54) REVERSIBLE LINEAR FEEDBACK SHIFT REGISTER CIRCUIT

(71) Applicant: NORTHROP GRUMMAN SYSTEMS CORPORATION, FALLS CHURCH, VA (US)

(72) Inventor: Kyle David Shiflett, Baltimore, MD (US)

(21) Appl. No.: 19/196,167

(22) Filed: May 1, 2025

(51) Int. Cl. G06F 7/58

(52) U.S. Cl. CPC G06F 7/584

(57) ABSTRACT

One example includes a reversible linear feedback shift register (LFSR) circuit. The circuit includes a plurality of bit cells configured to store respective logic bits that collectively correspond to a state of the reversible LFSR circuit. The circuit also includes a respective plurality of direction multiplexers. Each arranged as an input to a respective one of the bit cells. The direction multiplexers can be configured to control a direction of a bit-wise shift of the logic bits through the reversible LFSR circuit. The circuit further includes feedback interconnect logic arranged at an input of each of at least a portion of the direction multiplexers to control the state of the reversible LFSR circuit in response to the bit-wise shift of the logic bits.

### TECHNICAL FIELD

The present disclosure relates generally to computer circuits, and specifically to a reversible linear feedback shift register circuit.

### GOVERNMENT INTEREST

The invention was made under Government Contract. Therefore, the US Government has rights to the invention as specified in that contract.

### BACKGROUND

Computer systems often implement shift registers to manipulate a linear sequence of data. One type of shift register is a linear feedback shift register (LFSR) that can be implemented for a variety of purposes. One example is implementing an LFSR as a digital counter, and another as a pseudo-random number generator. LFSR systems can cycle data stored in the linear array of data cells in a single direction, using feedback from one or more cells to feed inputs to other cells. Unidirectional shifting can provide for basic counting operations of the given LFSR circuit. LFSR circuits can be reset to set the data therein to an initial state, which is typically implemented as a fixed sequence of data.

### SUMMARY

One example includes a reversible linear feedback shift register (LFSR) circuit. The circuit includes a plurality of bit cells configured to store respective logic bits that collectively correspond to a state of the reversible LFSR circuit. The circuit also includes a respective plurality of direction multiplexers. Each of the direction multiplexers can be arranged as an input to a respective one of the bit cells. The direction multiplexers can be configured to control a direction of a bit-wise shift of the logic bits through the reversible LFSR circuit. The circuit further includes feedback interconnect logic arranged at an input of each of at least a portion of the direction multiplexers to control the state of the reversible LFSR circuit in response to the bit-wise shift of the logic bits.

Another example includes a method for operating a reversible LFSR circuit. The method includes providing an input serial data stream to the reversible LFSR circuit to provide initial values for logic bits to a plurality of bit cells of the reversible LFSR circuit. The method also includes providing a direction signal in a first direction state to each of a respective plurality of direction multiplexers to provide a forward direction of a bit-wise shift of the logic bits through the reversible LFSR circuit. The method further includes providing the direction signal in a second direction state to each of the direction multiplexers to provide a reverse direction of the bit-wise shift of the logic bits through the reversible LFSR circuit.

Another example includes a reversible LFSR circuit. The circuit includes a plurality of bit cells configured to store respective logic bits that collectively correspond to a state of the reversible LFSR circuit. The logic bits can correspond to a first logic state associated with a presence of an RQL pulse at a given phase of an RQL clock signal or a second logic state associated with an absence of the RQL pulse at the given phase of the RQL clock signal. The circuit also includes a respective plurality of direction multiplexers. Each of the direction multiplexers can be arranged as an input to a respective one of the bit cells. The direction multiplexers can be configured to control a direction of a bit-wise shift of the logic bits through the reversible LFSR circuit. The circuit further includes feedback interconnect logic arranged at an input of each of at least a portion of the direction multiplexers to control the state of the reversible LFSR circuit in response to the bit-wise shift of the logic bits.

### BRIEF DESCRIPTION OF THE DRAWINGS

FIG. 1 is an example block diagram of a reversible linear feedback shift register (LFSR) system.

FIG. 2 is an example block diagram of a reversible LFSR circuit.

FIG. 3 is an example diagram of a reversible LFSR circuit.

FIG. 4 is an example diagram of a stage of a reciprocal quantum logic (RQL) reversible LFSR circuit.

FIG. 5 is an example of a method for operating a reversible LFSR circuit.

### DETAILED DESCRIPTION

This present disclosure relates generally to computer circuits, and specifically to a reversible linear feedback shift register (LFSR) circuit. A reversible LFSR circuit described herein can be implemented as an LFSR that can be selectively bit-wise shifted in either a forward direction or a reverse direction. The reversible LFSR circuit can include a plurality of bit cells that each store a logic bit corresponding collectively to a state of the reversible LFSR circuit. The reversible LFSR circuit also includes a respective plurality of direction multiplexers that are each arranged at an input of one of the respective bit cells. The direction multiplexers each include a first input associated with the forward direction (e.g., a forward bit-wise shift) and a second input associated with the reverse direction (e.g., a reverse bit-wise shift), such that the inputs are controlled by a direction signal that is input to each of the direction multiplexers. The reversible LFSR circuit further includes feedback interconnect logic arranged between an output of at least one of the bit cells and selected input(s) of the direction multiplexers. The feedback interconnect logic thus controls the state of the reversible LFSR circuit during the forward or reverse bit-wise shifting of the logic bits.

As an example, the reversible LFSR circuit can be implemented as a reciprocal quantum logic (RQL) circuit, such that the direction multiplexers can include a set of Josephson transmission lines (JTLs) and RQL logic gates. The logic bits can each thus correspond to the presence of an RQL pulse at a given phase of an RQL clock signal in a first state and an absence of an RQL pulse at the given phase of an RQL clock signal in a second state. As described herein, an RQL pulse is defined as a positive fluxon followed by a negative fluxon at opposing phases of the RQL clock signal. In this example, the direction multiplexers can each receive a forward direction RQL pulse to provide for a forward direction bit-wise shift of the logic bits and a reverse direction RQL pulse to provide for a reverse direction bit-wise shift of the logic bits. Furthermore, the direction RQL pulses can be implemented to provide for a hold state of the logic bits in the reversible LFSR circuit, such as based on hold state logic being arranged as a logic XNOR gate with respect to the direction RQL pulses.

By providing the reversible LFSR circuit as having reversible operation, the reversible LFSR circuit can provide both increment and decrement operations for a digital counter, as opposed to conventional LFSR circuits. In addition, unlike conventional LFSR circuits, the reversible LFSR circuit can be seeded with variable states to provide for greater flexibility in operation. Furthermore, the reversible LFSR circuit can be implemented at improved operational speed and with a significantly reduced gate-count relative to similar conventional circuits, such as Kogge-Stone, One-Hot, and other conventional LFSR counters.

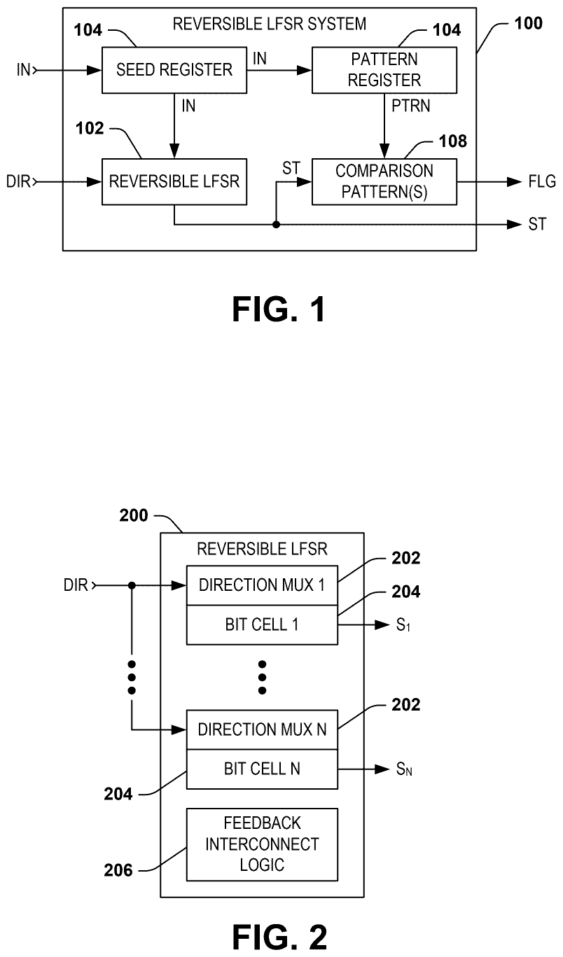

FIG. 1 is an example block diagram of reversible linear feedback shift register (LFSR) system 100. The reversible LFSR system 100 can be implemented in any of a variety of computer applications to provide for applications requiring a digital counter and/or a pseudo-random number generator. The reversible LFSR system 100 can be implemented for use in conventional complementary metal oxide semiconductor (CMOS) computers, or can be implemented in a superconductor computer system, as described in greater detail herein.

The reversible LFSR system 100 includes a reversible LFSR circuit 102. The reversible LFSR circuit 102 can be implemented to selectively bit-wise shift logic bits stored therein in either a forward direction or a reverse direction. The reversible LFSR circuit 102 can include a plurality of bit cells that each store a respective one of the logic bits that correspond collectively to a state ST of the reversible LFSR circuit 102. The reversible LFSR circuit 102 also includes a respective plurality of direction multiplexers that are each arranged at an input of one of the respective bit cells. The direction multiplexers each include a first input associated with the forward direction (e.g., a forward bit-wise shift) and a second input associated with the reverse direction (e.g., a reverse bit-wise shift), such that the inputs are controlled by a direction signal DIR that is input to each of the direction multiplexers. The reversible LFSR circuit 102 can thus provide both increment and decrement operations, such as based on operation as a digital counter. The reversible LFSR circuit 102 further includes feedback interconnect logic arranged between an output of at least one of the bit cells and selected input(s) of the direction multiplexers. The feedback interconnect logic thus controls the state ST of the reversible LFSR circuit 102 during the forward or reverse bit-wise shifting of the logic bits.

In the example of FIG. 1, the reversible LFSR system 100 also includes a seed register 104 that is configured to provide an initial state of the reversible LFSR circuit 102. The seed register 104 can be arranged as a linear shift register that is configured to receive a serial data stream IN that is fed as an input to the reversible LFSR system 100. The serial data stream IN, upon being provided fully to the seed register 104, can thus be provided as an input to the reversible LFSR circuit 102, such as in a bit-wise manner. For example, each bit cell of the seed register 104 can be provided to a respective one of the bit cells of the reversible LFSR circuit 102. Therefore, based on the seed register 104 being provided the serial data stream IN, and based on the serial data stream IN being provided as an input to the reversible LFSR circuit 102 to set an initial state of the reversible LFSR circuit 102, the reversible LFSR circuit 102 can be seeded with variable states to provide for greater flexibility in operation.

In addition, the reversible LFSR system 100 includes a pattern register 106. The pattern register 106 can be arranged as a linear shift register that is arranged to receive a serial data stream IN that is provided through the seed register 104. For example, the seed register 104 and the pattern register 106 can collectively correspond to a single long shift register having two approximately equal portions in bitlength. The serial data stream IN, having passed through the seed register 104, can thus be provided as a predefined state pattern PTRN to a comparison pattern(s) block 108.

The comparison pattern(s) block 108 can correspond to one or more registers configured to store a state to which a state ST of the reversible LFSR circuit 102 is compared. As an example, the comparison pattern(s) block 108 can include one or more temporary registers configured to store a respective one or more predefined patterns PTRN to which the state ST of the reversible LFSR circuit 102 is compared, and/or can include one or more permanent registers configured to store a respective one or more hardcoded patterns to which the state ST of the reversible LFSR circuit 102 is compared. In response to the state ST of the reversible LFSR circuit 102 being equal to a given one of the patterns in the comparison pattern(s) block 108, the comparison pattern(s) block 108 can provide a flag signal FLG that is indicative of the match of the state ST of the reversible LFSR circuit 102 being equal to a given one of the patterns in the comparison pattern(s) block 108.

FIG. 2 is an example block diagram of a reversible LFSR circuit 200. The reversible LFSR circuit 200 can correspond to the reversible LFSR circuit 102 in the example of FIG. 1, and can thus be included in a reversible LFSR system (e.g., the reversible LFSR system 100). Therefore, reference is to be made to the example of FIG. 1 in the following description of the example of FIG. 2. As described above, the reversible LFSR circuit 200 can be implemented to selectively bit-wise shift logic bits stored therein in either a forward direction or a reverse direction.

The reversible LFSR circuit 200 includes a plurality N of bit cells 202, where N is a positive integer greater than one, that each store a respective one of the logic bits that correspond collectively to a state ST of the reversible LFSR circuit 200. The reversible LFSR circuit 200 also includes a respective plurality N of direction multiplexers 204 (“DIRECTION MUX X”, where X is an index) that are each arranged at an input of one of the respective bit cells 202. To implement the selective bidirectional bit-wise shifting, the direction multiplexers 204 each include a first input associated with the forward direction (e.g., a forward bit-wise shift) and a second input associated with the reverse direction (e.g., a reverse bit-wise shift). The selection of the inputs via the direction multiplexers 204 is controlled by a direction signal DIR that is input to each of the direction multiplexers 204. The reversible LFSR circuit 200 can thus provide both increment and decrement operations based on the respective forward and reverse bit-wise shifting.

The reversible LFSR circuit 200 further includes feedback interconnect logic 206. In the example of FIG. 2, the feedback interconnect logic 206 is demonstrated as a standalone block within the reversible LFSR circuit 200. However, the feedback interconnect logic 206 can be arranged as one or more logic gates (e.g., logic XOR gates) arranged between an output of at least one of the bit cells 202 and selected input(s) of the direction multiplexers 204. The feedback interconnect logic 206 thus controls the state ST of the reversible LFSR circuit 200 during the forward or reverse bit-wise shifting of the logic bits. In the example of FIG. 2, the state ST of the reversible LFSR circuit 200 collectively represents each of bits S₁ through S_{N} that are stored in the respective bit cells 202.

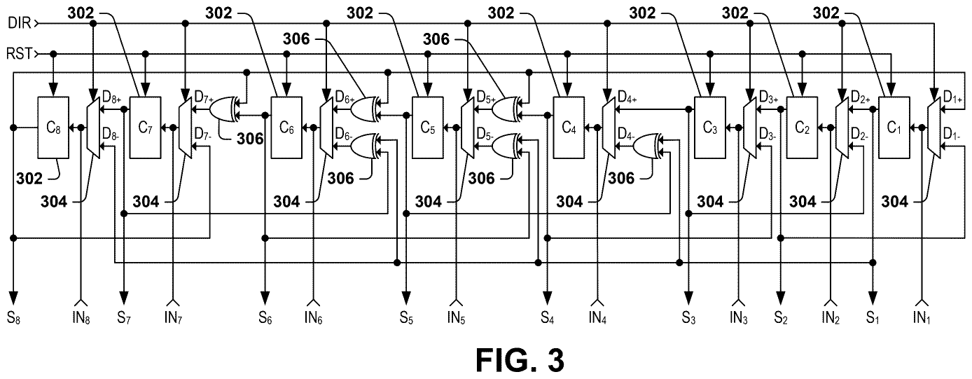

FIG. 3 is an example diagram of a reversible LFSR circuit 300. The reversible LFSR circuit 300 can correspond to the reversible LFSR circuits 102 and/or 200 in the respective examples of FIGS. 1 and/or 2, and can thus be included in a reversible LFSR system (e.g., the reversible LFSR system 100). Therefore, reference is to be made to the examples of FIGS. 1 and 2 in the following description of the example of FIG. 3. As described above, the reversible LFSR circuit 300 can be implemented to selectively bit-wise shift logic bits stored therein in either a forward direction or a reverse direction. The reversible LFSR circuit 300 depicted in the example of FIG. 3 is but one example of a reversible LFSR circuit. Reversible LFSR circuits having a variety of different features can be implemented similarly based on the description herein.

The reversible LFSR circuit 300 includes eight bit cells 302, labeled C₁ through C₈. Each of the bit cells 302 is configured to store a respective one of the logic bits that correspond collectively to a state ST of the reversible LFSR circuit 300, demonstrated as bits S₁ through S₈ provided at the outputs of the respective bit cells 302. The reversible LFSR circuit 300 also includes eight respective direction multiplexers 304 that are each arranged at an input of one of the respective bit cells 302. In the example of FIG. 3, each of the direction multiplexers 304 includes a first input that provides a data signal D_{X+}, where X is an index, associated with the forward direction (e.g., a forward bit-wise shift), and includes a second input that provides a data signal D_{X-} associated with the reverse direction (e.g., a reverse bit-wise shift). Each of the direction multiplexers 304 is configured to receive a direction signal DIR that controls which input of the direction multiplexers 304 is provided as an output to the respective bit cells 302, and thus controls whether the reversible LFSR circuit 300 implements a forward bit-wise shift or a reverse bit-wise shift.

In the example of FIG. 3, the first bit cell 302 (C₁) receives an input from a first direction multiplexer 304. The first direction multiplexer 304 receives a forward shift data signal D₁₊ corresponding to the state bit S₈ output from the eighth bit cell 302 (C₈), and receives a reverse shift data signal D₁₋corresponding to the state bit S₂ output from the second bit cell 302 (C₂). The second bit cell 302 (C₂) receives an input from a second direction multiplexer 304. The second direction multiplexer 304 receives a forward shift data signal D₂₊ corresponding to the state bit S₁ output from the first bit cell 302 (C₁), and receives a reverse shift data signal D₂₋corresponding to the state bit S₃ output from the third bit cell 302 (C₃).

The third bit cell 302 (C₃) receives an input from a third direction multiplexer 304. The third direction multiplexer 304 receives a forward shift data signal D₃₊corresponding to the state bit S₂ output from the second bit cell 302 (C₂), and receives a reverse shift data signal D₃₋corresponding to the state bit S₄ output from the fourth bit cell 302 (C₄). The fourth bit cell 302 (C₄) receives an input from a fourth direction multiplexer 304. The fourth direction multiplexer 304 receives a forward shift data signal D₄₊ corresponding to the state bit S₃ output from the third bit cell 302 (C₃), and receives a reverse shift data signal D₄₋ from a logic XOR gate 306. The logic XOR gate 306 receives a first input from the state bit S₁ output from the first bit cell 302 (C₁) and a second input from the state bit S₅ output from the fifth bit cell 302 (C₅).

The fifth bit cell 302 (C₅) receives an input from a fifth direction multiplexer 304. The fifth direction multiplexer 304 receives a forward shift data signal D₅₊ from a logic XOR gate 308. The logic XOR gate 308 receives a first input from the state bit S₈ output from the eighth bit cell 302 (C₈) and a second input from the state bit S₄ output from the fourth bit cell 302 (C₄). The fifth direction multiplexer 304 receives a reverse shift data signal D₅₋ from a logic XOR gate 310. The logic XOR gate 310 receives a first input from the state bit S₁ output from the first bit cell 302 (C₁) and a second input from the state bit S₆ output from the sixth bit cell 302 (C₆).

The sixth bit cell 302 (C₆) receives an input from a sixth direction multiplexer 304. The sixth direction multiplexer 304 receives a forward shift data signal D₆₊from a logic XOR gate 312. The logic XOR gate 312 receives a first input from the state bit S₈ output from the eighth bit cell 302 (C₈) and a second input from the state bit S₅ output from the fifth bit cell 302 (C₅). The sixth direction multiplexer 304 receives a reverse shift data signal D₆₋ from a logic XOR gate 314. The logic XOR gate 314 receives a first input from the state bit S₁ output from the first bit cell 302 (C₁) and a second input from the state bit S₇ output from the seventh bit cell 302 (C₇).

The seventh bit cell 302 (C₇) receives an input from a seventh direction multiplexer 304. The seventh direction multiplexer 304 receives a forward shift data signal D₇₊from a logic XOR gate 316. The logic XOR gate 316 receives a first input from the state bit S₈ output from the eighth bit cell 302 (C₈) and a second input from the state bit S₆ output from the sixth bit cell 302 (C₆). The seventh direction multiplexer 304 receives a reverse shift data signal D₇₋ corresponding to the state bit S₈ output from the eight bit cell 302 (C₈). The eighth bit cell 302 (C₈) receives an input from an eighth direction multiplexer 304. The eighth direction multiplexer 304 receives a forward shift data signal D₈₊ corresponding to the state bit S₇ output from the seventh bit cell 302 (C₇), and receives a reverse shift data signal D₈₋ corresponding to the state bit S₁ output from the first bit cell 302 (C₁).

The logic XOR gates 306, 308, 310, 312, 314, and 316 can correspond collectively to feedback interconnect logic (e.g., the feedback interconnect logic 206). The logic XOR gates 306, 308, 310, 312, 314, and 316 thus control the state ST of the reversible LFSR circuit 300 during the forward or reverse bit-wise shifting of the logic bits S₁ through S₈.

In addition, as demonstrated in the example of FIG. 3, the reversible LFSR circuit 300 can receive input bits IN1 through IN8 that can be provided to the inputs of the respective bit cells 302. The input bits IN1 through IN8 can collectively correspond to the serial data stream IN that can be provided from the seed register 104, and can thus set an initial variable state of the reversible LFSR circuit 300. Furthermore, in the example of FIG. 3, a reset signal RST can be provided to reset the state ST of the reversible LFSR circuit 300. For example, the reset signal RST can correspond to a logic-1 to set the state of the reversible LFSR circuit 300 to a sequence of logic-1 values in each of the bit cells 302.

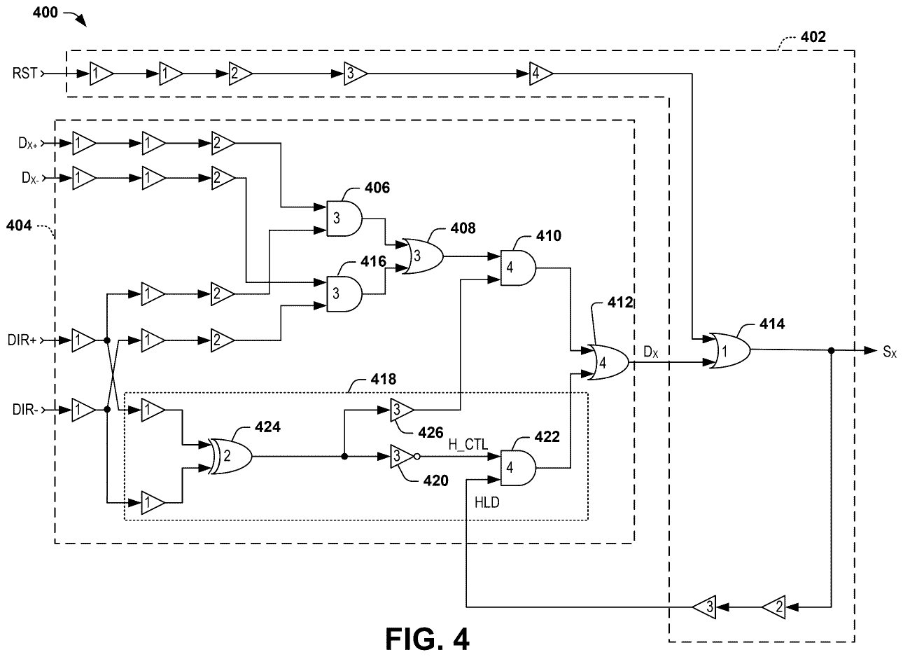

As described above, the reversible LFSR circuits 102, 200, and 300 can be implemented as RQL logic circuits, such that the logic bits can each correspond to a presence of an RQL pulse in a first logic state and an absence of an RQL pulse in a second logic state. An example implementation of RQL for the reversible LFSR circuits described herein is demonstrated in the example of FIG. 4.

FIG. 4 is an example diagram 400 of a stage of an RQL reversible LFSR circuit. The stage in the diagram 400 can correspond to a combination of a single bit cell and a single respective direction multiplexer. Therefore, reference is to be made to the examples of FIGS. 1-3 in the following description of the example of FIG. 4.

In the example of FIG. 4, the diagram 400 demonstrates a bit cell 402 and a direction multiplexer 404. The bit cell 402 and the direction multiplexer 404 each include a set of Josephson transmission line (JTL) stages and logic gates, demonstrated as logic AND gates and logic OR gates. Each of the JTL stages, the logic AND gates, and the logic OR gates have an associated RQL phase designation, demonstrated as phase designations 1, 2, 3, and 4, corresponding to one of the phases of an RQL clock. For example, the phase designations can correspond to separate respective 90° phase increments of the RQL clock (e.g., 0°, 90°, 180°, and 270°). The phase designations can thus correspond to ordered biasing of the JTL stages, the logic AND gates, and the logic OR gates to provide presence or absence of RQL pulses at the respective phase. The example set of JTL stages, logic AND gates, and logic OR gates are demonstrated simplistically in the example of FIG. 4, and thus may also include additional same phase JTL stages that have been omitted for brevity.

The direction multiplexer 404 is demonstrated as receiving the forward shift data signal D_{X+} and the reverse shift data signal D_{X-}. The direction multiplexer 404 also receives the direction signal DIR, demonstrated in the example of FIG. 4 as a forward direction signal DIR+ and a reverse direction signal DIR-. As an example, the forward direction signal DIR+ can be provided as a forward direction RQL pulse that provides for a forward bit-wise shift of the respective reversible LFSR circuit, thereby providing the forward shift data signal D_{X+} as an input to the bit cell 402, and thus as the output logic bit S_{X} from the bit cell 402. Similarly, the reverse direction signal DIR-can be provided as a reverse direction RQL pulse that provides for a reverse bit-wise shift of the respective reversible LFSR circuit, thereby providing the reverse shift data signal D_{X-} as an input to the bit cell 402, and thus as the output logic bit S_{X} from the bit cell 402.

In the example of FIG. 4, in response to an RQL pulse provided as the forward direction signal DIR+, a logic AND gate 406 is configured to provide the state of the forward shift data signal D_{X+} to a logic OR gate 408. The logic OR gate 408 provides the state of the forward shift data signal D_{X+} to a logic AND gate 410, which provides the state to a logic OR gate 412 in the absence of a hold state. The logic OR gate 412 therefore provides the state of the forward shift data signal D_{X+} as an output signal D_{X}. The output signal D_{X} is provided as an input to a logic OR gate 414 in the bit cell 402. The logic OR gate 414 therefore provides the state of the forward shift data signal D_{X+} as an output corresponding to the logic bit S_{X}, thereby implementing a forward bit-wise shift of the reversible LFSR circuit via the respective stage that includes the direction multiplexer 404 and the bit cell 402 in response to the RQL pulse provided as the forward direction signal DIR+.

Similarly, in response to an RQL pulse provided as the reverse direction signal DIR-, a logic AND gate 416 is configured to provide the state of the reverse shift data signal D_{X-} to the logic OR gate 408. The logic OR gate 408 provides the state of the reverse shift data signal D_{X-} to the logic AND gate 410, which provides the state to the logic OR gate 412 in the absence of a hold state. The logic OR gate 412 therefore provides the state of the reverse shift data signal D_{X-} as the output signal D_{X}. The output signal D_{X} is provided as the input to the logic OR gate 414 in the bit cell 402. The logic OR gate 414 therefore provides the state of the reverse shift data signal D_{X-} as the output corresponding to the logic bit S_{X}, thereby implementing a reverse bit-wise shift of the reversible LFSR circuit via the respective stage that includes the direction multiplexer 404 and the bit cell 402 in response to the RQL pulse provided as the reverse direction signal DIR-.

In addition to the logic that defines forward and reverse bit-wise shifting, the direction multiplexer 404 also includes hold state logic 418. The hold state logic 418 can implement a hold state of the associated reversible LFSR circuit, and thus no bit-wise shift (neither forward nor reverse) in a given phase of the RQL clock signal. In the example of FIG. 4, an inverter 420, demonstrated as a JTL with an inverting output, provides a hold control signal H_CTL that is asserted to implement the hold state. For example, an RQL pulse provided as the hold control signal H_CTL, and thus activation of the hold state for the reversible LFSR circuit, is provided from the inverter 420 to a logic AND gate 422. The logic bit S_{X} is fed back to the logic AND gate 422 (via phase-ordered JTL stages) as a hold state bit HLD, and is thus output from the logic AND gate 422 as the same logic state based on the RQL pulse provided as the hold control signal H_CTL.

For example, if the logic bit S_{X} corresponds to a logic-0 (e.g., an absence of an RQL pulse), the absence of the RQL pulse is fed back to the logic AND gate 422 as the hold state bit HLD, such that the logic AND gate 422 likewise outputs no RQL pulse in response to the RQL pulse provided as the hold control signal H_CTL (e.g., at the “4” phase). The absence of the RQL pulse is provided to the logic OR gate 412, which therefore provides no RQL pulse, and thus the logic-0 output signal D_{X}, to the bit cell 402. Accordingly, the bit cell 402 can provide the logic bit S_{X} at the logic-0 state as an absence of the RQL pulse.

As another example, if the logic bit S_{X} corresponds to a logic-1 (e.g., a presence of an RQL pulse), the RQL pulse is fed back to the logic AND gate 422 as the hold state bit HLD, such that the logic AND gate 422 likewise outputs an RQL pulse in response to the RQL pulse provided as the hold control signal H_CTL (e.g., at the “4” phase). The RQL pulse output from the logic AND gate 422 is provided to the logic OR gate 412, which therefore provides an RQL pulse, and thus the logic-1 output signal D_{X}, to the bit cell 402. Accordingly, the bit cell 402 can provide the logic bit S_{X} at the logic-1 state as an RQL pulse.

In the example of FIG. 4, the hold state logic 418 operates as an XNOR gate with respect to the direction signals DIR+ and DIR− to provide the hold control signal H_CTL. As described above, an RQL pulse provided as the forward direction signal DIR+implements a forward bit-wise shift of the reversible LFSR circuit, and an RQL pulse provided as the reverse direction signal DIR− implements a reverse bit-wise shift of the reversible LFSR circuit. However, providing an RQL pulse for both the forward and reverse direction signals DIR+ and DIR−, or providing no RQL pulse for both the forward and reverse direction signals DIR+ and DIR−, implements no bit-wise shift and instead asserts the hold control signal H_CTL.

For example, in response to providing an RQL pulse for both the forward and reverse direction signals DIR+ and DIR− , a logic XOR gate 424 receives both RQL pulses at respective inputs. Therefore, the logic XOR gate 424 provides no RQL pulse to the inverter 420, or to a JTL stage 426. The JTL stage 426 thus provides no RQL pulse to the logic AND gate 410, thereby prohibiting the logic AND gate 410 from propagating any RQL pulses that could correspond to a first logic state of the forward shift data signal D_{X+} or the reverse shift data signal D_{X-}. However, the inverter 420 converts the absence of an RQL pulse to an RQL pulse, thereby asserting the hold control signal H_CTL.

As another example, in response to providing no RQL pulse for both the forward and reverse direction signals DIR+ and DIR−, the logic XOR gate 424 receives no RQL pulses at respective inputs. Therefore, the logic XOR gate 424 provides no RQL pulse to the inverter 420, or to the JTL stage 426. The JTL stage 426 thus provides no RQL pulse to the logic AND gate 410, thereby prohibiting the logic AND gate 410 from propagating any RQL pulses that could correspond to a first logic state of the forward shift data signal D_{X+} or the reverse shift data signal D_{X-}. However, the inverter 420 converts the absence of an RQL pulse to an RQL pulse, thereby asserting the hold control signal H_CTL.

In addition, the hold state logic 418 disables the hold state in response to either of the forward and reverse direction signals DIR+ and DIR− being provided without the other. In the example of one and only one of the forward and reverse direction signals DIR+ and DIR− providing an RQL pulse, the logic XOR gate 424 provides an RQL pulse to the inverter 420 and to the JTL stage 426. The JTL stage 426 thus provides the RQL pulse to the logic AND gate 410, thereby allowing the logic AND gate 410 to propagate any RQL pulses that could correspond to a first logic state of the forward shift data signal D_{X+} or the reverse shift data signal D_{X-}. However, the inverter 420 converts the RQL pulse to no RQL pulse, thereby de-asserting the hold control signal H_CTL and prohibiting the logic AND gate 422 from propagating the hold state bit HLD (e.g., as an RQL pulse).

Furthermore, in the example of FIG. 4, the bit cell 402 can receive a reset signal RST that is configured to reset the state of the bit cell 402. For example, the reset signal RST can force a logic-1 state into the bit cell 402 in response to a reset of the reversible LFSR circuit. In the example of FIG. 4, if the reset signal RST is provided as an RQL pulse (e.g., to indicate a reset), the RQL pulse is propagated through JTL stages to the logic OR gate 414. Therefore, the logic OR gate 414 provides the logic bit S_{X} as an RQL pulse, and thus a logic-1 reset state.

Accordingly, the example of FIG. 4 provides an exemplary implementation of the reversible LFSR circuit (e.g., the reversible LFSR circuit 102, 200, and/or 300) as an RQL circuit. The RQL reversible LFSR circuit can thus implement bidirectional bit-wise shifting, as described herein, and can be programmed with a variable initial state, as also described herein. Accordingly, the principles of operation of the reversible LFSR circuit can be implemented in both CMOS and RQL. As a result, the reversible LFSR circuit described herein can be implemented to provide bidirectional bit-wise shifting for digital counting operations while taking advantage of the benefits of an LFSR design. Thus, the reversible LFSR circuit described herein can operate faster, can have a more compact circuit package (e.g., reduced gate count), and can have a lower area delay product (ADP) than other conventional bidirectional digital counter circuits (e.g., Kogge-Stone and/or One-Hot).

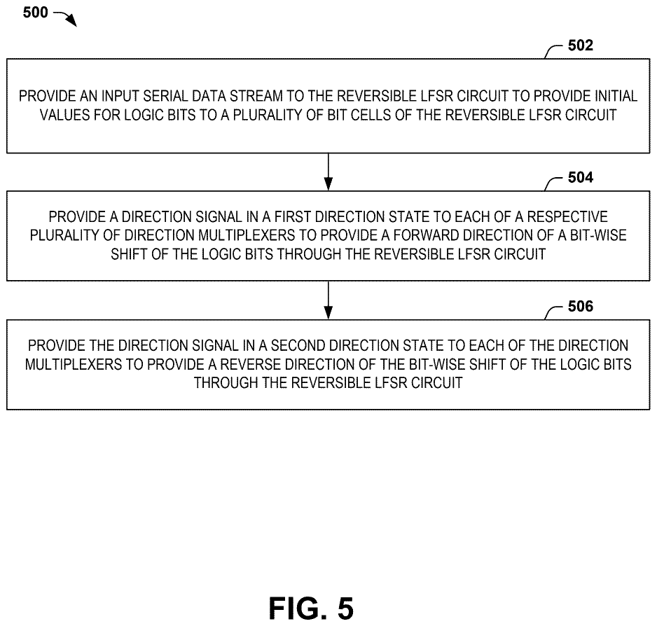

In view of the foregoing structural and functional features described above, a methodology in accordance with various aspects of the present invention will be better appreciated with reference to FIG. 5. While, for purposes of simplicity of explanation, the methodology of FIG. 5 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

FIG. 5 is an example of a method 500 for operating a reversible LFSR circuit (e.g., the reversible LFSR circuit 102). At 502, an input serial data stream (e.g., the input serial data stream IN) is provided to the reversible LFSR circuit to provide initial values for logic bits (e.g., the logic bits S corresponding to the state ST) to a plurality of bit cells (e.g., the bit cells 202) of the reversible LFSR circuit. At 504, a direction signal (e.g., the direction signal DIR) is provided in a first direction state (e.g., the forward direction signal DIR+) to each of a respective plurality of direction multiplexers (e.g., the direction multiplexers 204) to provide a forward direction of a bit-wise shift of the logic bits through the reversible LFSR circuit. At 506, the direction signal is provided in a second direction state (e.g., the reverse direction signal DIR−) to each of the direction multiplexers to provide a reverse direction of the bit-wise shift of the logic bits through the reversible LFSR circuit.

What have been described above are examples. It is, of course, not possible to describe every conceivable combination of components or methodologies for purposes of description, but one of ordinary skill in the art will recognize that many further combinations and permutations are possible. Accordingly, the description is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A reversible linear feedback shift register (LFSR) circuit comprising:
a plurality of bit cells configured to store respective logic bits that collectively correspond to a state of the reversible LFSR circuit;
a respective plurality of direction multiplexers, each arranged as an input to a respective one of the bit cells, the direction multiplexers being configured to control a direction of a bit-wise shift of the logic bits through the reversible LFSR circuit; and
feedback interconnect logic arranged at an input of each of at least a portion of the direction multiplexers to control the state of the reversible LFSR circuit in response to the bit-wise shift of the logic bits.

2. The circuit of claim 1, wherein each of the direction multiplexers are controlled by a direction signal having a first direction state associated with a first input of the direction multiplexers and a second direction state associated with a second input of the direction multiplexers, wherein the first direction state provides a forward direction of the bit-wise shift of the logic bits through the reversible LFSR circuit and the second direction state provides a reverse direction of the bit-wise shift of the logic bits through the reversible LFSR circuit.

3. The circuit of claim 2, wherein the direction signal has a third direction state associated with a hold of the state of the reversible LFSR circuit corresponding to no bit-wise shift of the logic bits.

4. The circuit of claim 1, wherein the reversible LFSR circuit is arranged as a reversible LFSR reciprocal quantum logic (RQL) circuit, such that the logic bits correspond to a first logic state associated with a presence of an RQL pulse at a given phase of an RQL clock signal or a second logic state associated with an absence of the RQL pulse at the given phase of the RQL clock signal.

5. The circuit of claim 4, wherein each of the direction multiplexers comprises a set of Josephson transmission lines (JTLs) and RQL logic gates, wherein each of the direction multiplexers is configured to receive a forward direction RQL pulse to provide a forward direction of the bit-wise shift of the logic bits through the reversible LFSR circuit based on the RQL clock signal, or to receive a reverse direction RQL pulse to provide a reverse direction of the bit-wise shift of the logic bits through the reversible LFSR circuit based on the RQL clock signal.

6. The circuit of claim 5, wherein the set of JTLs and RQL logic gates in each of the direction multiplexers comprises hold state logic configured to provide a hold state of the logic bits to maintain the logic bits in the respective bit cells with no bit-wise shift at the given phase of the RQL clock signal.

7. The circuit of claim 6, wherein the hold state logic is arranged as a logic XNOR-gate with respect to the forward and reverse direction RQL pulses, such that the hold state is provided in response to the presence of or absence of both of the forward and reverse direction RQL pulses.

8. The circuit of claim 4, wherein each of the bit cells comprises a reset input configured to receive a reset RQL pulse to reset the logic bits of the reversible LFSR circuit.

9. A reversible LFSR system comprising the reversible LFSR circuit of claim 1, the system further comprising a seed register configured to receive an input serial data stream, the input serial data stream being provided to the reversible LFSR circuit to provide initial values for the logic bits of the reversible LFSR circuit.

10. The system of claim 9, the system further comprising a comparison pattern buffer configured to store a comparison pattern, the system being further configured to compare the logic bits of the reversible LFSR circuit with the comparison pattern and to provide an output indication signal based on the comparison.

11. A method for operating a reversible linear feedback shift register (LFSR) circuit, the method comprising:
providing an input serial data stream to the reversible LFSR circuit to provide initial values for logic bits to a plurality of bit cells of the reversible LFSR circuit;
providing a direction signal in a first direction state to each of a respective plurality of direction multiplexers to provide a forward direction of a bit-wise shift of the logic bits through the reversible LFSR circuit; and
providing the direction signal in a second direction state to each of the direction multiplexers to provide a reverse direction of the bit-wise shift of the logic bits through the reversible LFSR circuit.

12. The method of claim 11, further comprising providing the direction signal in a third direction state to each of the direction multiplexers to hold a state of the reversible LFSR circuit corresponding to no bit-wise shift of the logic bits.

13. The method of claim 11, wherein providing the input serial data stream comprises providing the input serial data stream as an input reciprocal quantum logic (RQL) data stream, such that the logic bits correspond to a first logic state associated with a presence of an RQL pulse at a given phase of an RQL clock signal or a second logic state associated with an absence of the RQL pulse at the given phase of the RQL clock signal.

14. The method of claim 13, wherein providing the direction signal in the first direction state comprises providing a forward direction RQL pulse to provide the forward direction of the bit-wise shift of the logic bits through the reversible LFSR circuit based on the RQL clock signal, wherein providing the direction signal in the second direction state comprises providing a reverse direction RQL pulse to provide the reverse direction of the bit-wise shift of the logic bits through the reversible LFSR circuit based on the RQL clock signal.

15. The method of claim 14, wherein providing the first and second direction RQL pulses comprises providing the first and second direction RQL pulses to hold state logic arranged as a logic XNOR-gate, such that a hold state is provided in response to the presence of or absence of both of the forward and reverse direction RQL pulses.

16. A reciprocal quantum logic (RQL) reversible linear feedback shift register (LFSR) circuit comprising:
a plurality of bit cells configured to store respective logic bits that collectively correspond to a state of the reversible LFSR circuit, the logic bits corresponding to a first logic state associated with a presence of an RQL pulse at a given phase of an RQL clock signal or a second logic state associated with an absence of the RQL pulse at the given phase of the RQL clock signal;
a respective plurality of direction multiplexers, each arranged as an input to a respective one of the bit cells, the direction multiplexers being configured to control a direction of a bit-wise shift of the logic bits through the reversible LFSR circuit; and
feedback interconnect logic arranged at an input of each of at least a portion of the direction multiplexers to control the state of the reversible LFSR circuit in response to the bit-wise shift of the logic bits.

17. The circuit of claim 16, wherein each of the direction multiplexers comprises a set of Josephson transmission lines (JTLs) and RQL logic gates, wherein each of the direction multiplexers is configured to receive a forward direction RQL pulse to provide a forward direction of the bit-wise shift of the logic bits through the reversible LFSR circuit based on the RQL clock signal, or to receive a reverse direction RQL pulse to provide a reverse direction of the bit-wise shift of the logic bits through the reversible LFSR circuit based on the RQL clock signal.

18. The circuit of claim 17, wherein the set of JTLs and RQL logic gates in each of the direction multiplexers comprises hold state logic configured to provide a hold state of the logic bits to maintain the logic bits in the respective bit cells with no bit-wise shift at the given phase of the RQL clock signal.

19. The circuit of claim 18, wherein the hold state logic is arranged as a logic XNOR-gate with respect to the forward and reverse direction RQL pulses, such that the hold state is provided in response to the presence of or absence of both of the forward and reverse direction RQL pulses.

20. The circuit of claim 16, wherein each of the bit cells comprises a reset input configured to receive a reset RQL pulse to reset the logic bits of the reversible LFSR circuit.
